(19) United States
(12) Patent Application Publication
(10) Pub. No.: US 2003/0110859 A1
(43) Pub. Date: Jun. 19, 2003

(54) Acceleration sensors and pedometers using same

(76) Inventors: Ryoichi Fukui, Matsuzaka (JP); Naoki Sone, Tsu (JP)

Correspondence Address: BEYER WEAVER & THOMAS LLP, P.O. BOX 778, BERKELEY, CA, 94704-0778, US

(21) Appl. No.: 10/293,970

(22) Filed: Nov. 12, 2002

(30) Foreign Application Priority Data
Nov. 14, 2001 (JP) 2001-349026

(51) Int. Cl. G01P 15/00

(52) U.S. Cl. 73/514.36

(57) ABSTRACT

An acceleration sensor for a pedometer has a base member which bends along one plane, a piezoelectric element which is set on and bends with this base member, and a weight member at one end portion of the base member. The weight member causes the base member and the piezoelectric element to be deformed when it is accelerated in whatever direction. A pedometer includes such an acceleration sensor and outputs from the acceleration sensor are processed by a control circuit and the number of steps taken by the user or the distance walked by the user can be displayed on a display device.

### BACKGROUND OF THE INVENTION

This invention relates to acceleration sensors and pedometers. In particular, this invention relates to sensors capable of detecting accelerations in different directions, as well as pedometers using such acceleration sensors.

Pedometers using two acceleration sensors for detecting accelerations in various directions have been known. FIG. 14 shows an example of such a prior art pedometer 200, comprised of a rear case 110, a base plate 120 contained in the rear case 110, two acceleration sensors 210 and a liquid crystal display 130 set on this base plate 120, a front case 150 to be engaged with the rear case 110, an inscription plate 170 set on the surface of the front case 150 and a switch 140 inserted into a hole in the front case 150. Each of the two acceleration sensors 210 has one of its end parts affixed to the base plate 120. As the base plate 120 is moved with the pedometer 200 in a certain direction, its acceleration is detected by the acceleration sensors 210, and the number of steps taken by the user can be determined from this detected acceleration.

As shown more clearly in FIG. 15, each of the acceleration sensors 210 includes a base member 201, a weight member 203 at an end portion 201a of the base member 201, a piezoelectric element 202 and a supporting member 207 at the other end portion 201b of the base member 201. A lead line 205 is electrically connected to the piezoelectric element 202 by means of a solder material 206. The lead line 205 is comprised of a conductive line 205b at the center and an insulting layer 205a surrounding the conductive line 205b. The conductive line 205b at the center is electrically connected to the piezoelectric element 202. The supporting member 207 is electrically connected to the base plate 120 shown in FIG. 14.

When the acceleration sensor 210 undergoes an acceleration in the z-direction, the weight member 203 vibrates in the z-direction and hence both the base member 201 and the piezoelectric element 202 become deformed. This deformation causes a potential difference to appear between the two surfaces of the piezoelectric element 202. The potential difference thus generated is detected through the lead line 205 such that the acceleration can be detected.

The acceleration sensor 210 shown in FIG. 15 can thus detect accelerations in the z-direction but cannot detect accelerations in the x-direction or the y-direction. For this reason, two acceleration sensors 210 are set as shown in FIG. 14 in mutually independent directions such that accelerations in two directions can be detected. With a prior art pedometer as described above, however, there remained the problems of increased size and production cost because two acceleration sensors 210 were used.

In view of these problems, Japanese Patent Publication Tokkai 5-273227 disclosed an acceleration sensor with its weight member disposed with its center of gravity displaced such that accelerations in two directions can be detected by a single acceleration sensor. With this acceleration sensor, however, it is difficult to dependably detect accelerations in a plurality of directions.

### SUMMARY OF THE INVENTION

It is therefore an object of this invention to provide an acceleration sensor such that accelerations in a plurality of directions can be detected with a single sensor.

It is another object of this invention to provide a pedometer using such an acceleration sensor.

An acceleration sensor embodying this invention, with which the above and other objects can be accomplished, may be characterized as comprising a base member which bends along one plane, a piezoelectric element which is set on and bends with this base member, and a weight member at one end portion of the base member. With an acceleration sensor thus structured, the weight member causes the base member and the piezoelectric element to be deformed no matter in what direction the weight member attached at one end portion of the base member is displaced because the base member and the piezoelectric element are bent in and along one plane. Since this deformation allows the piezoelectric element to detect the acceleration, the user can reliably detect accelerations in all direction with a single acceleration sensor. Since the outer (convex) surface of the bent piezoelectric element can be worked upon more accurately, it is preferable to attach the piezoelectric element to the inner (concave) surface of the bent base member as they are pasted together. In this manner, the piezoelectric element can be adjusted on the base member more accurately and a more reliable acceleration sensor can be provided.

According to a preferred embodiment of the invention, the piezoelectric element and the base member are bent in a circular form because a piezoelectric element in such a bent form is easier to manufacture and hence the production cost can be reduced. For this purpose, a cylindrical piezoelectric element may be preliminarily produced which may be cut to obtain circularly arcuate elements.

A supporting member may be further provided on the opposite end part of the base member away from the weight member for attaching to a baseboard. The weight member may be dispensed with if the base member and the piezoelectric element are properly designed.

A pedometer embodying this invention may be characterized as comprising not only an acceleration sensor embodying this invention as characterized above, a control circuit for processing signals outputted from the acceleration sensor and calculating the number of steps taken by the user carrying it or the distance traveled by the user from the number of steps (referred to as the “pedometric outputs”), and a display device for displaying such a pedometric output generated by the control circuit.

### BRIEF DESCRIPTION OF THE DRAWINGS

FIG. 1 is a diagonal exploded view of an acceleration sensor according to a first embodiment of the invention and a pedometer provided therewith.

FIG. 2 is an enlarged diagonal view of the acceleration sensor shown in FIG. 1.

FIG. 3 is a side view of the acceleration sensor shown in FIG. 2 as shown along the z-axis.

FIG. 4 is a side view of the acceleration sensor shown in FIG. 2 as shown along the y-axis.

FIG. 5 is a graph showing the potential difference measured by a pedometer embodying this invention.

FIG. 6 is a diagonal view of an acceleration sensor according to a second embodiment of the invention.

FIG. 7 is a diagonal view of an acceleration sensor according to a third embodiment of the invention.

FIG. 8 is a diagonal view of an acceleration sensor according to a fourth embodiment of the invention.

FIG. 9 is a diagonal view of an acceleration sensor according to a fifth embodiment of the invention.

FIG. 10 is a diagonal view of an acceleration sensor according to a sixth embodiment of the invention.

FIG. 11 is a diagonal view of an acceleration sensor according to a seventh embodiment of the invention.

FIG. 12 is a diagonal view of an acceleration sensor according to an eighth embodiment of the invention.

FIG. 13 is a block diagram of a control system of a pedometer embodying this invention.

FIG. 14 is an exploded diagonal view of a prior art pedometer.

FIG. 15 is an enlarged diagonal view of the acceleration sensor shown in FIG. 13.

Throughout herein, equivalent or similar components are indicated by the same symbols even where they are components of different sensors according to different embodiments of the invention and may not be repetitiously described.

### DETAILED DESCRIPTION OF THE INVENTION

The invention is described next by way of examples.

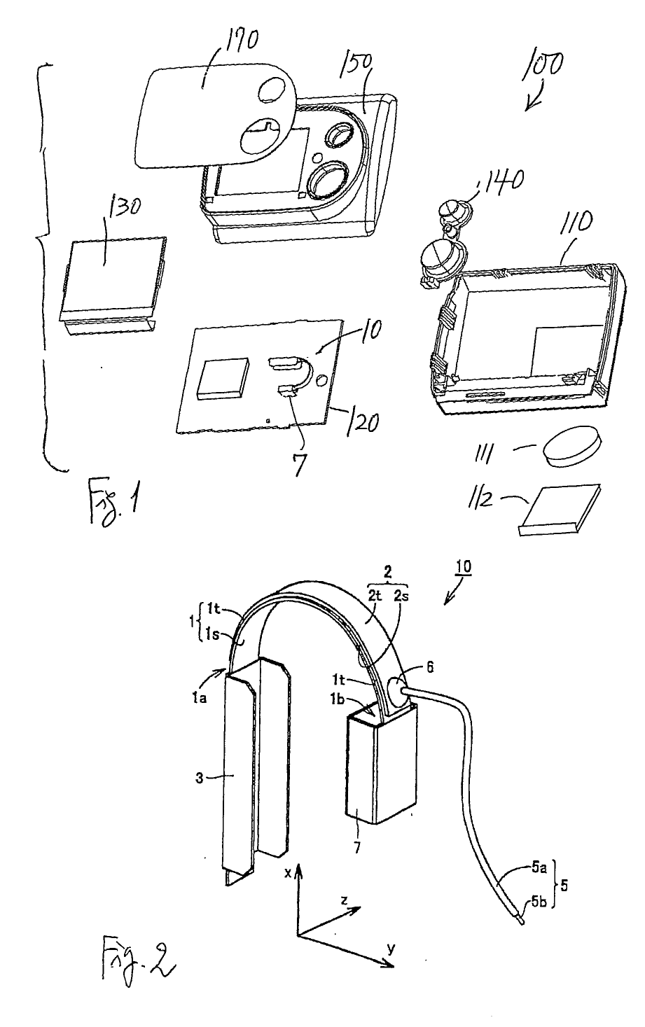

FIG. 1 shows an acceleration sensor 10 according to a first embodiment of this invention and a pedometer 100 which makes use thereof, comprising a rear case 110, a base plate 120 contained in the rear case 110, a button-shaped battery 111 and a battery lid 112, the acceleration sensors 10 and a liquid crystal display 130 set on this base plate 120, a front case 150 to be engaged with the rear case 110, an inscription plate 170 set on the surface of the front case 150 and a switch 140 inserted into a hole in the front case 150. The acceleration sensor 10 has a supporting member 7 which is affixed to the base plate 120.

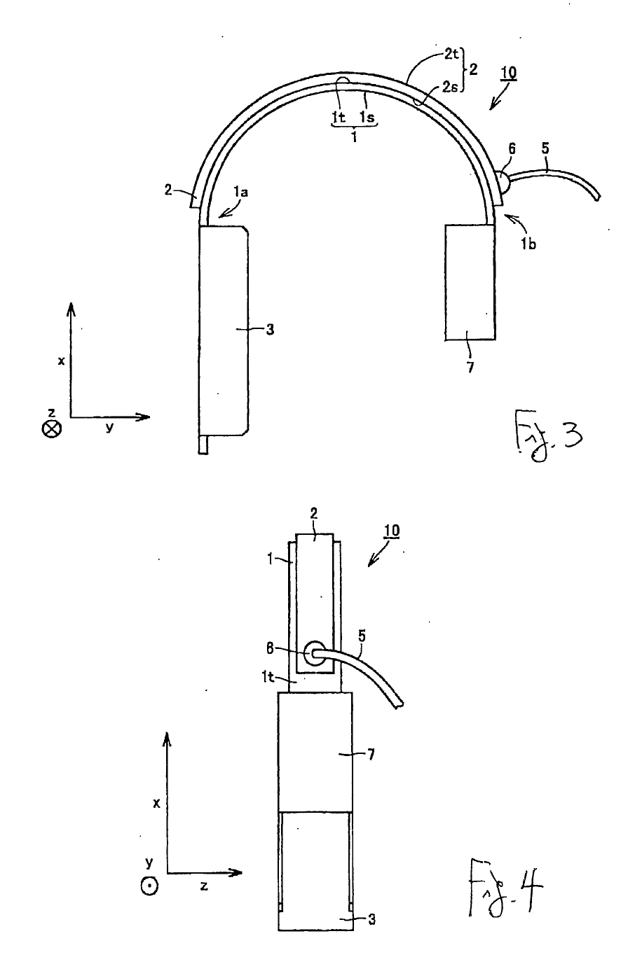

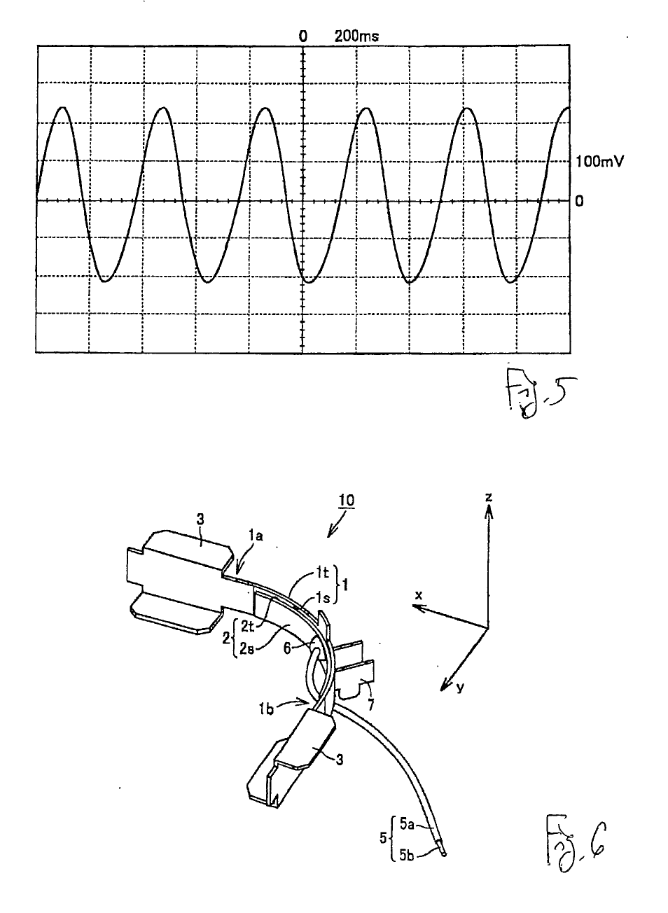

As shown in FIGS. 2, 3 and 4, the acceleration sensor 10 is comprised of a base member 1 adapted to bend in one plane (the x-y plane as shown), a piezoelectric element 2 set on the base member 1 so as to bend with the base member 1 and a weight member 3 at one end portion 1a of the base member 1. As shown, both the piezoelectric element 2 and the base member 1 are adapted to bend together in an arcuate manner. The acceleration sensor 10 is further provided with a supporting member 7 on the other end portion 1b of the base member away from the weight member 3, affixed to the base plate 120 shown in FIG. 1.

The base member 1 is a thin metallic plate in an arcuate form. Its inner and outer surfaces are respectively indicated by symbols is and It. The piezoelectric element 2 may be a ceramic element, say, comprising lead titanate zirconate (PZT) or a polymer element, being pasted on the outer surface it of the base member 1 and bending together with the base member 1.

The piezoelectric element 2, thus bent into an arcuate form, may be produced as a single product. Alternatively, a piezoelectric element may be formed in a cylindrical form and an appropriate portion of this cylindrical element may be cut and used for the purpose of this invention. The inner and outer surfaces of the piezoelectric element 2 are respectively indicated by symbols 2s and 2t. Its inner surface 2s is pasted to the outer surface 1t of the base member 1. Since the base member 1 is electrically connected to the base plate 120 through the supporting member 7, the inner surface 2s of the piezoelectric element 2 is electrically connected to the base plate 120. The outer surface 2t of the piezoelectric element 2 is electrically connected to a lead line 5 through a solder material 6. The lead line 5 is comprised of a conductive line 5b at the center and an insulating layer 5a surrounding the conductive line 5b. The conductive line 5b at the center is electrically connected to the outer surface 2t of the piezoelectric element 2.

If the piezoelectric element 2 becomes deformed, a potential difference appears between its inner and outer surfaces 2s and 2t. Since this potential difference becomes the potential difference between the base plate 120 and the conductive line 5b of the lead line 5, this may be used to detect the acceleration of the acceleration sensor 10.

As can be seen in FIG. 3, the base member 1 and the piezoelectric element 2 are bent together in one plane (the xy-plane) such that they both have the same center of curvature but they are not curved when seen in the xz-plane (or along the y-direction) or in the yz-plane (or along the x-direction). If the acceleration sensor 10 is accelerated in the y-direction, its weight member 3 vibrates in the y-direction, causing the piezoelectric element 2 to be deformed and generating a potential difference. The acceleration can be detected by detecting this potential difference. If the acceleration sensor 10 is accelerated in the x-direction or z-direction, the weight member 3 vibrates respectively in the x-direction and the z-direction, causing the piezoelectric element 2 to be deformed and generating a potential difference. The acceleration can be similarly detected by detecting this potential difference.

FIG. 5 is a graph for showing the potential difference measured by a pedometer embodying this invention, as shown at 100 in FIG. 1 with an acceleration sensor as shown at 10. For the purpose of this graph, this pedometer was subjected to vibrations with frequency f=2.3 Hz, acceleration a=0.28 g (g being the gravitational acceleration) and a total amplitude of 15 mm. FIG. 5 shows the waveform obtained by the pedometer 100. It is clear that a product capable of providing such a waveform can function as a pedometer.

In summary, since the acceleration sensor according to this invention comprises a base plate and a piezoelectric element that are both bent along a curved plane, it can detect an acceleration in any direction. In other words, a single acceleration sensor according to this invention can dependably detect accelerations in all directions. Since the base plate and the piezoelectric element are both disposed in a bent form, furthermore, both the acceleration sensor itself and the pedometer which makes use of it can be made compact. The vibrations of the weight member 3 are quickly attenuated and hence do not lead to a detection error.

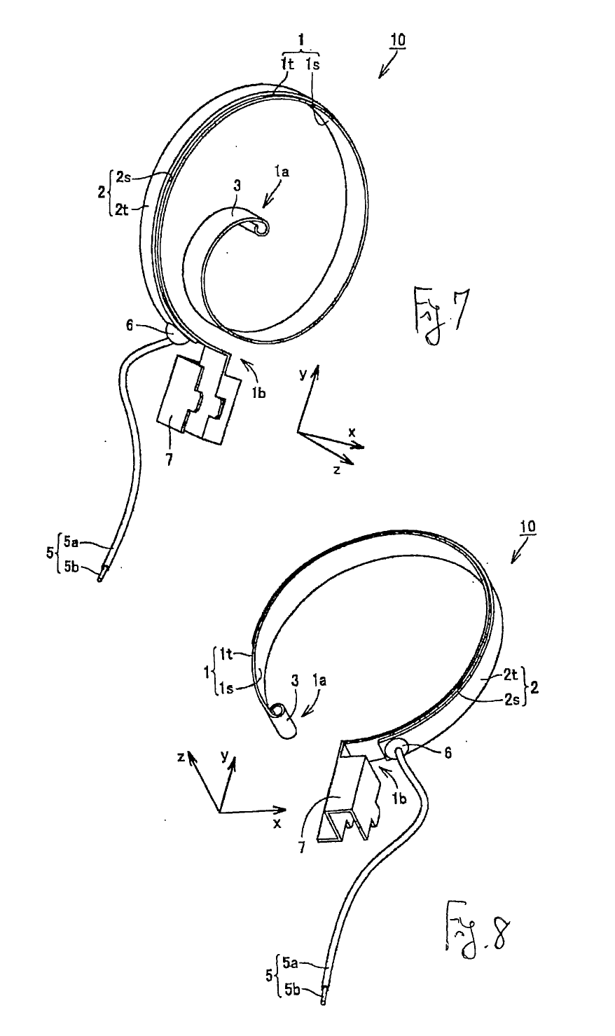

FIG. 6 shows another acceleration sensor 10 according to a second embodiment of the invention, characterized as having two weight members 3 provided at both end portions 1a and 1b of the base member 1 bent along the xy-plane and a supporting member 7 at a center portion of the base member 1. The piezoelectric element 2 is bent along and attached to the base member 1. The outer surface 2t of the curved piezoelectric element 2 is pasted and attached to the curved inner surface 1s of the base member 1. The lead line 5 is soldered to the base member 1.

The acceleration sensor 10 thus structured has the same merits as those according to the first embodiment of the invention described above. Since the piezoelectric element 2 is on the inner concave side of the curvature, and since the accuracy of the outer surface 2t of the piezoelectric element 2 can be improved more easily, a more reliable acceleration sensor 10 can be provided by pasting a base member 1 on the highly accurately formed outer surface 2t of the piezoelectric element 2.

Explained more in detail, the surface of the piezoelectric element 2 on which the base member 1 is pasted on must be polished because the pasting cannot be effected accurately if the contact surface is rough with indentations and protrusions but it is easier to polish the outer surface 2t than the inner surface 2s and hence the production cost can be reduced. When the polishing process is carried out on a cylindrical form, it is particularly easier to polish the outer surface 2t than the inner surface 2s.

FIG. 7 shows still another acceleration sensor 10 according to a third embodiment of the invention, characterized as having a base member 1 which is spirally curved in one plane (the xy-plane), a piezoelectric element 2 which is similarly curved in a spiral form, and a weight member 3 formed as one end portion 1a of the base member 1. The curvature of the base member 1, as well as that of the piezoelectric element 2, increases as the end portion 1a is approached. The piezoelectric element 2 does not extend to the end portion 1a of the base member 1. In other words, the end portion 1a of the base member 1 which is formed as the weight element 3 is not covered by the piezoelectric element 2. The inner surface 2s of the piezoelectric element 2 contacts directly the outer surface 1t of the base member 1. The acceleration sensor 10 thus structured according to the third embodiment of the invention has the same merits as those according to the first embodiment of the invention described above.

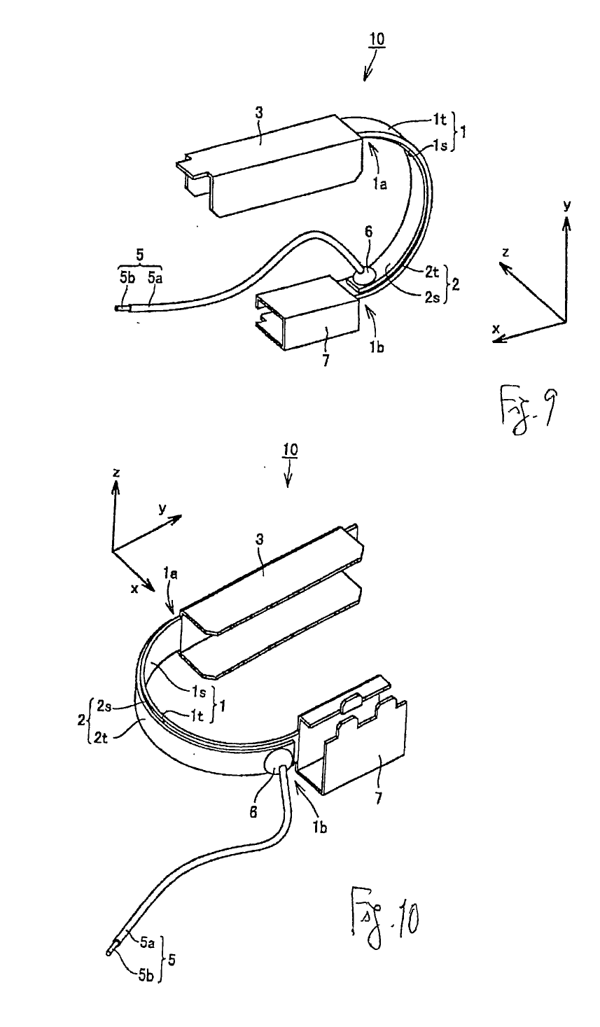

FIG. 8 shows still another acceleration sensor 10 according to a fourth embodiment of the invention, characterized as comprising a base member 1 which is bent in a circular form in a plane (the xy-plane), a piezoelectric element 2 similarly bent and formed concentrically with the base member 1 and a weight member 3 formed by rolling an end portion 1a of the base member 1. The base member 1 and the piezoelectric element 2 are in an annular form, the inner surface 2s of the piezoelectric element 2 directly contacting the outer surface it of the base member 1. The acceleration sensor 10 thus structured according to the fourth embodiment of the invention has the same merits as those according to the first embodiment of the invention described above.

FIG. 9 shows still another acceleration sensor 10 according to a fifth embodiment of the invention, characterized as comprising a base member 1 which is bent in a plane (the xy-plane) and a piezoelectric element 2 similarly bent and having its outer surface 2t contacting the inner surface 1s of the base member 1. Thus, the fifth embodiment is different from the second embodiment wherein the piezoelectric element 2 is inside the base member 1. The acceleration sensor 10 thus structured according to the fifth embodiment of the invention has the same merits as those according to the first embodiment of the invention described above. Since the outer surface 2t of the piezoelectric element 2 contacts the base member 1, furthermore, it also has the merits of the second embodiment.

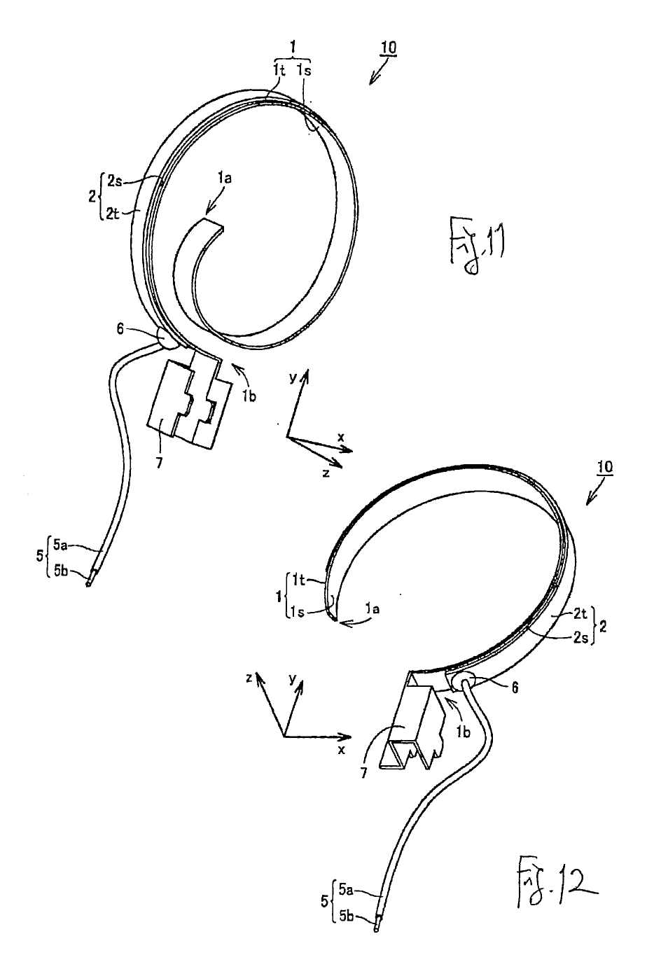

FIG. 10 shows still another acceleration sensor 10 according to a sixth embodiment of the invention, characterized as comprising a base member 1 which is bent in a plane (the xy-plane), a piezoelectric element 2 which is similarly bent and a weight member 3 at one end portion 1a of the base member 1. It is different from the first embodiment wherein the supporting member 7 is formed so as to protrude in the direction of the outer surface 1t of the base member 1. The acceleration sensor 10 thus structured according to the sixth embodiment of the invention has the same merits as those according to the first embodiment of the invention described above.

FIG. 11 shows still another acceleration sensor 10 according to a seventh embodiment of the invention, characterized as being different from the third embodiment described above with reference to FIG. 7 wherein the weight member 3 is dispensed with since accelerations can be detected without the weight member 3 if the material, thickness and width of the base member 1 and the piezoelectric element 2 are properly adjusted. The acceleration sensor 10 thus structured according to the seventh embodiment of the invention has the same merits as those according to the first and third embodiments of the invention described above. Since the weight member 3 of the third embodiment is dispensed with, furthermore, the production cost can be reduced.

FIG. 12 shows still another acceleration sensor 10 according to an eighth embodiment of the invention, characterized as comprising a base member 1 which is bent in a circular form in a plane (the xy-plane) and a piezoelectric element 2 similarly bent and formed concentrically with the base member 1. The base member 1 and the piezoelectric element 2 are in an annular form, the inner surface 2s of the piezoelectric element 2 directly contacting the outer surface 1t of the base member 1. The acceleration sensor 10 thus structured according to the eighth embodiment of the invention has the same merits as those according to the seventh embodiment of the invention described above.

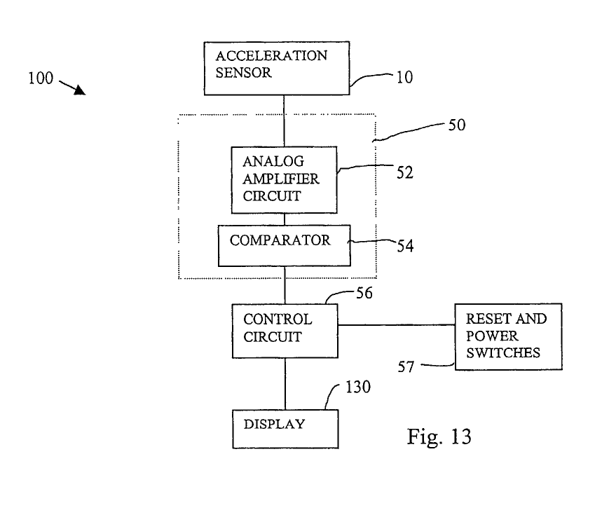

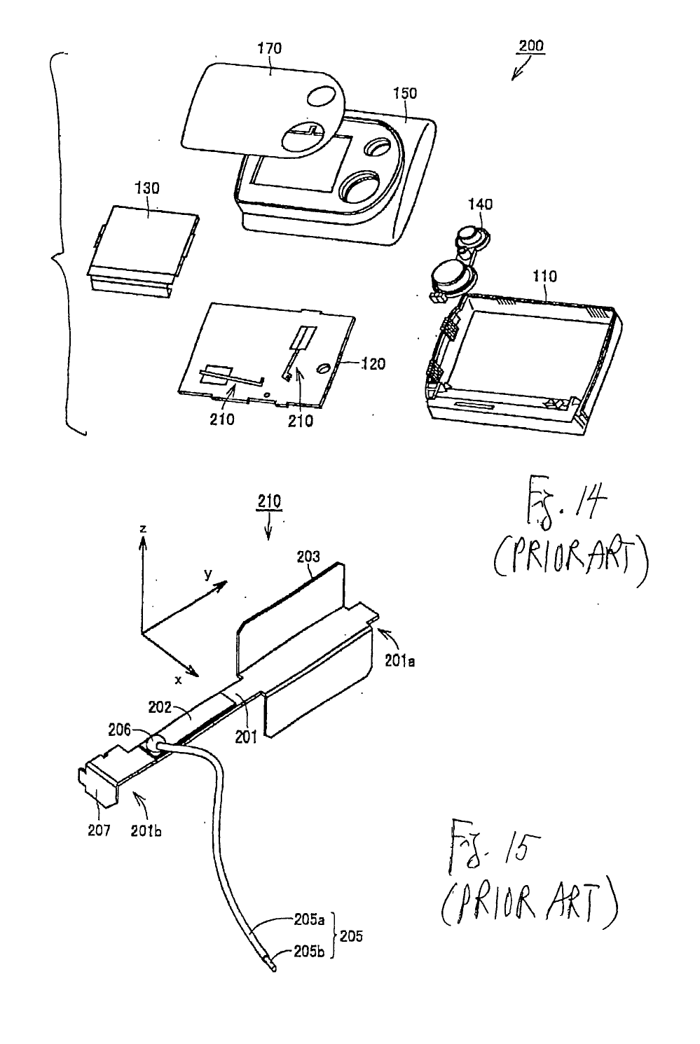

A control system for a pedometer 100 embodying this invention is schematically shown in FIG. 13. Signals outputted from an acceleration sensor 10 embodying this invention described above are passed through an analog circuit 50 comprising an analog amplifier circuit 52 and a comparator 54 and received by a control circuit 56 serving to generate a signal indicative of the number of steps taken by the user or a distance walked by the user. Such a signal will be herein referred to as the pedometric output and is displayed on the display device 130. In FIG. 13, numeral 57 indicates reset and power switches for the pedometer 100. It should be clear from the description given above that a pedometer according to this invention has the advantage of requiring only one acceleration sensor to detect body accelerations in all directions and hence can be made compact while being able to provide dependable pedometric outputs.

Although the invention has been described above with reference to only a limited number of embodiments, these illustrated embodiments are not intended to limit the scope of the invention. Many modifications and variations are possible within the scope of this invention. All such modifications and variations that may be apparent to a person skilled in the art are intended to be included within the scope of the invention.

What is claimed is:

1. An acceleration sensor comprising:
a base member which bends along one plane; and
a piezoelectric element set on said base member, said piezoelectric element bending with said base member.

2. The acceleration sensor of claim 1 further comprising a weight member at one end portion of said base member.

3. The acceleration sensor of claim 2 wherein said piezoelectric element is on an inner concave side of said bent base member.

4. The acceleration sensor of claim 2 wherein said base member and said piezoelectric element are bent in a circular form.

5. The acceleration sensor of claim 3 wherein said base member and said piezoelectric element are bent in a circular form.

6. The acceleration sensor of claim 2 further comprising a supporting member attached to another end portion of said base member away from the end portion with said weight member.

7. The acceleration sensor of claim 3 further comprising a supporting member attached to another end portion of said base member away from the end portion with said weight member.

8. The acceleration sensor of claim 4 further comprising a supporting member attached to another end portion of said base member away from the end portion with said weight member.

9. The acceleration sensor of claim 5 further comprising a supporting member attached to another end portion of said base member away from the end portion with said weight member.

10. A pedometer comprising:
an acceleration sensor having a base member which bends along one plane, a piezoelectric element set on said base member, and a weight member at one end portion of said base member, said piezoelectric element bending with said base member;
a control circuit for processing signals outputted from said acceleration sensor and generating a pedometric output therefrom; and
a display device for displaying said pedometric output generated by said control circuit.

11. The pedometer of claim 10 wherein said piezoelectric element is on an inner concave side of said bent base member.

12. The pedometer of claim 10 wherein said base member and said piezoelectric element are bent in a circular form.

13. The pedometer of claim 11 wherein said base member and said piezoelectric element are bent in a circular form.

14. The pedometer of claim 11 further comprising a supporting member attached to another end portion of said base member away from the end portion with said weight member.

15. A pedometer comprising:
an acceleration sensor having a base member which bends along one plane and a piezoelectric element set on said base member, said piezoelectric element bending with said base member;
a control circuit for processing signals outputted from said acceleration sensor and generating a pedometric output therefrom; and
a display device for displaying said pedometric output generated by said control circuit.

16. The pedometer of claim 15 wherein said piezoelectric element is on an inner concave side of said bent base member.

17. The pedometer of claim 15 wherein said base member and said piezoelectric element are bent in a circular form.

18. The pedometer of claim 16 wherein said base member and said piezoelectric element are bent in a circular form.

19. The pedometer of claim 15 further comprising a supporting member attached to another end portion of said base member away from the end portion with said weight member.

20. The pedometer of claim 16 further comprising a supporting member attached to another end portion of said base member away from the end portion with said weight member.
